(19) United States
(12) Patent Application Publication
(10) Pub. No.: US 2005/0160938 A1
(43) Pub. Date: Jul. 28, 2005

(54) Liquid inks comprising stabilizing organosols

(75) Inventors: Ronald J. Moudry, Woodbury, MN (US); James A. Baker, Hudson, WI (US)

Correspondence Address: Mark A. Litman & Associates, P.A., York Business Center, Suite 205, 3209 West 76th St., Edina, MN, 55435, US

(73) Assignee: SAMSUNG Electronics Co., Ltd.

(21) Appl. No.: 11/088,998

(22) Filed: Mar. 22, 2005

Related U.S. Application Data
(63) Continuation-in-part of application No. 10/334,398, filed on Dec. 31, 2002, now Pat. No. 6,905,807.
(60) Provisional application No. 60/347,184, filed on Jan. 8, 2002.
(60) Provisional application No. 60/346,946, filed on Jan. 8, 2002.

(51) Int. Cl. G03G 9/00

(52) U.S. Cl. 106/31.87

(57) ABSTRACT

A liquid ink for developing electrophotography images comprises: a) a carrier liquid having a Kauri-Butanol number less than 30; b) a pigment having at least one acid group or at least one acid group; c) optionally a grafted co-polymer comprising a (co)polymeric steric stabilizer covalently bonded to a thermoplastic (co)polymeric core that is insoluble in the carrier liquid, wherein the grafted co-polymer is derived from at least a polymerizable organic compound; d) a dispersant having, respectively, at least an amine group or at least one acid group to form an acid-base pigment-dispersant system or a base-acid pigment-dispersant system, wherein the mole ratio of the amine group to the acid group is between 0.3 and 1.5 in the base-acid pigment-dispersant system and the mole ratio of the acid group to the base group in the acid-base pigment dispersant system is between 0.3 and 1.5; and d) a positive charge director with the acid-base pigment-charge dispersant system and a negative charge director with the base-acid pigment charge-dispersant system.

### RELATED APPLICATION DATA

This Application is a Continuation-in-Part of U.S. patent application Ser. No. 10/334,398 filed Dec. 31, 2002, which in turn claims priority from both U.S. Provisional Patent Application No. 60/347,184, filed Jan. 8, 2002; and U.S. Provisional Patent Application No. 60/346,946, filed Jan. 8, 2002.

### BACKGROUND OF THE INVENTION

1. Field of the Invention

This invention relates to liquid ink compositions comprising a charge director, a grafted co-polymer having at least one acidic group or at least one basic group, and a dispersant having at least one basic group or at least one acid group, respectively. In particular, this invention relates to a liquid ink which exhibits improved dispersion stability and improved chargeability when used in any imaging process, including but not limited to ink transfer processes, ionographic processes, electrographic processes and electrophotographic color printing processes or proofing processes.

2. Background of the Art

Liquid inks are widely used in a variety of imaging and printing processes, for example offset, bubble jet, ink jet, intaglio, rotogravure, electrographic, and electrophotographic printing. Many characteristics desired in pigment dispersions for liquid inks are the same for each of the respective processes even though the final ink formulations may be substantially different. For example, the stability of the pigment dispersion on the shelf, under shear conditions, and under high voltage fields is an important consideration regardless of the final use of the liquid ink. The art continuously searches for more stable pigment dispersions to provide more flexibility in ink formulations to provide better efficiency and waste reduction in the various printing processes.

In electrophotographic applications, which include devices such as photocopiers, laser printers, facsimile machines and the like, liquid inks are referred to as liquid toners or developers. Generally, the electrophotographic process includes the steps of forming a latent electrostatic image on a charged photoconductor by exposing the photoconductor to radiation in an imagewise pattern, developing a temporary image on the photoconductor by contacting the photoconductor with a liquid ink, and finally transferring the temporary image to a receptor. The final transfer step may be performed either directly from the photoconductor or indirectly through an intermediate transport member. The developed image is usually subjected to heat and/or pressure to permanently fuse the image to the receptor.

Liquid inks typically comprise an electrically insulating liquid that serves as a carrier for a dispersion of charged particles, known as toner particles. These toner particles are composed of at least a colorant (e.g. pigment or dye) and a polymeric binder. A charge control agent is often included as a component of the liquid developer to regulate the polarity and magnitude of the charge on the toner particles. Liquid inks can be categorized into two primary classes. For convenience, the two classes will be referred to as conventional liquid inks and organosol inks.

One problem in formulating liquid inks is the difficulty in obtaining liquid inks that have excellent dispersion stability. It is always desirable to obtain liquid ink compositions having excellent dispersion stability.

An important consideration in formulating liquid inks is the chargeability of the liquid ink. It is desirable for a liquid ink to have a high chargeability so that it can acquire enough quantity of charge to be forced under an electrical field to migrate and then to plate upon the imaged areas on the photoreceptor. The chargeability of a liquid ink is measured by its conductivity and its mobility. In general, liquid inks with high ink conductivity and high ink mobility are desirable.

This invention provides a liquid ink with a novel composition that exhibits increased dispersion stability and improved chargeability.

### SUMMARY OF THE INVENTION

In a first aspect, the invention features a liquid ink that includes:
a) a carrier liquid having a Kauri-Butanol number less than 30;
b) a pigment comprising an acid group or a basic group associated with a corresponding (basic group or acid group) functional dispersant;
c) a functional dispersant having at least an amine group when the pigment has at least one acid group and the dispersant having at least one acid group when the pigment has at least one basic group. The first system is referred to herein as an acid-base pigment-dispersant system, and the second system is referred to as a base-acid pigment-dispersant system. The order in the names is indicative of the presence of the acid or basic group on the respective order of the materials (e.g., acid-base refers to the acid pigment and the basic dispersant in the pigment-dispersant system). In the basic-acidic system, the mole ratio of the amine group to the acid group is between 0.3 and 1.5; in the acidic-basic system, the mole ratio of the acid group to the amine group is between 0.3 and 1.5; and
d) a positive charge director, and
e) grafted co-polymer organosol comprising a (co)polymeric steric stabilizer covalently bonded to a thermoplastic (co)polymeric core that is insoluble in the carrier liquid, wherein the grafted co-polymer is optionally derived from at least a polymerizable organic compound having at least one acid group or at least one basic group.

The liquid inks of the present invention will be described primarily with respect to electrophotographic office printing; however, it is to be understood that these liquid toners are not so limited in their utility and may also be employed in other imaging processes, other printing processes, or other ink transfer processes, such as high speed printing presses, photocopying apparatus, microfilm reproduction devices, facsimile printing, ink jet printer, instrument recording devices, and the like.

### DETAILED DESCRIPTION OF THE INVENTION

A liquid ink includes:
a) a carrier liquid having a Kauri-Butanol number less than 30;
b) a pigment having at least one surface acid or base group;
c) a grafted co-polymer comprising a (co)polymeric steric stabilizer covalently bonded to a thermoplastic (co)polymeric core that is insoluble in the carrier liquid, wherein the grafted co-polymer is optionally derived from at least a polymerizable organic compound having at least one acid group or at least one basic group;
d) a functional dispersant having at least an amine group when the pigment and/or grafted copolymer has at least one acid group and the functional dispersant having at least one acid group when the pigment and/or grafted copolymer has at least one basic group; and
e) a positive charge director.
   This balancing of interacting functional groups on the grafted copolymer or pigment and the dispersant can be referred to as an acidic-basic pigment copolymer dispersant system. There are two acidic-basic systems described above. The first system is referred to herein as an acid-base pigment copolymer-dispersant system, and the second system is referred to as a base-acid pigment copolymer dispersant system. The order in the names is indicative of the presence of the acid or base group on the respective order of the materials (e.g., acid-base refers to the acid pigment and/or copolymer and the basic dispersant in the copolymer-dispersant system). In the base-acid system, the mole ratio of the amine group to the acid group is between 0.3 and 1.5; in the acid-base system, the mole ratio of the acid group to the amine group is between 0.3 and 1.5; and

A liquid ink composition is provided comprising an organosol comprising a binder dispersed in a liquid having a Kauri-Butanol (KB) number less than 30, colorant, a functional dispersant, and a charge control agent. “Kauri-Butanol” refers to an ASTM Test Method D1133-54T. The Kauri-Butanol Number (KB) is a measure of the tolerance of a standard solution of Kauri resin in 1-butanol to an added hydrocarbon diluent and is measured as the volume in milliliters (mL) at 25° C. of the solvent required to produce a certain defined degree of turbidity when added to 20 g of a standard Kauri-1-butanol solution. Standard values are toluene (KB=105) and 75% by volume of heptane with 25% by volume toluene (KB=40).

The carrier liquid may be selected from a wide variety of materials that are known in the art, but the carrier liquid preferably has a Kauri-Butanol number less than 30. The liquid is typically oleophilic, chemically stable under a variety of conditions, and electrically insulating. Electrically insulating refers to a liquid having a low dielectric constant and a high electrical resistivity. Preferably, the liquid has a dielectric constant of less than 5, more preferably less than 3. Electrical resistivities of carrier liquids are typically greater than 10⁹ Ohm-cm, more preferably greater than 10¹⁰ Ohm-cm. The carrier liquid preferably is also relatively nonviscous to allow movement of the charged particles during development, and sufficiently non-volatile to minimize evaporative losses in the stored developer. In addition, the carrier liquid should be chemically inert with respect to the materials or equipment used in the liquid electrophotographic process, particularly the photoreceptor and its release surface.

Non-limiting examples of suitable carrier liquids include aliphatic hydrocarbons (n-pentane, hexane, heptane and the like), cycloaliphatic hydrocarbons (cyclopentane, cyclohexane and the like), aromatic hydrocarbons (benzene, toluene, xylene and the like), halogenated hydrocarbon solvents (chlorinated alkanes, fluorinated alkanes, chlorofluorocarbons, and the like), silicone oils and blends of these solvents. Preferred carrier liquids include branched paraffinic solvent blends such as Isopar™ G, Isopar™ H, Isopar™ K, Isopar™ L, Isopar™ M and Isopar™ V (available from Exxon Corporation, N.J.), and most preferred carriers are the aliphatic hydrocarbon solvent blends such as Norpar™ 12, Norpar™ 13 and Norpar™ 15 (available from Exxon Corporation, N.J.).

The binder in this invention is an organosol. The organosol binder may optionally have either acidic groups or basic groups to interact strongly with the colorant particles so that a stable dispersion can be obtained. Furthermore, dispersion stability and chargeability can be improved significantly by the addition of a dispersant with an opposite acidity or basicity to the binder. For example, if a positive charge director such as a metallic carboxylate is used, an organosol binder comprising acidic groups and a dispersion with basic groups can be used to improve dispersion stability and chargeability. On the other hand, if a negative charge director is used, an organosol binder comprising basic groups and a dispersion with acidic groups can be used to improve dispersion stability and chargeability.

An organosol is an amphipathic copolymer dispersed in a carrier liquid. The amphipathic copolymer comprises a soluble or marginally insoluble high molecular weight (co)polymeric steric stabilizer covalently bonded to an insoluble, thermoplastic (co)polymeric core.

Applicants are not to be limited by the theories of the operation of the practice of the invention, although the descriptions provided herein enable practice of the invention as claims. There may well be potential advantages of the present invention that can include improved stability of the liquid ink dispersion (owing to the presence of ionic bonds between the grafted copolymer and the dispersant as opposed to less strong van der Waals forces commonly present in such associations), and improved charge stability of the liquid ink (owing to the presence of ionic bonds between the grafted copolymer, the dispersant, and the charge director). The presence of amine and acid functional groups can improve the interaction of the grafted copolymer with the dispersant, charge director, and pigment thereby improving ink stability and temperature stability. The presence of amine and acid functional groups can improve interaction of the printed image with polymeric and cellulosic (e.g., paper) substrates, thereby improving the durability of the printed image, and thereby lowering the temperature required to fuse the image to the substrate.

Table 1 lists the Kauri-Butanol Number and Hildebrand solubility parameter for some common carrier liquids used in electrophotographic toners and Table 2 lists the Hildebrand solubility parameter and glass transition Temperature of common monomers.

TABLE 1
Solvent Values at 25° C.

| | Kauri-Butanol Number | Hildebrand |
|---|---|---|
| | by ASTM Method | Solubility |
| Solvent Name | D1133-54T (mL) | Parameter (MPa^{1/2}) |
| Norpar ™ 15 | 18 | 13.99 |
| Norpar ™ 13 | 22 | 14.24 |
| Norpar ™ 12 | 23 | 14.30 |
| Isopar ™ V | 25 | 14.42 |
| Exxsol ™ D80 | 28 | 14.60 |

Source: Calculated from equation #31 of Polymer Handbook, 3rd Ed., J. Brandrup E. H. Immergut, Eds. John Wiley, N.Y., p. VII/522 (1989).

TABLE 2
Monomer Values at 25° C.

| | Hildebrand Solubility | Glass Transition |
|---|---|---|
| Monomer Name | Parameter (MPa^{1/2}) | Temperature (° C.)* |
| n-Octadecyl | 16.77 | −100 |
| Methacrylate | | |
| n-Octadecyl Acrylate | 16.82 | −55 |
| Lauryl Methacrylate | 16.84 | −65 |
| Lauryl Acrylate | 16.95 | −30 |
| 2-Ethylhexyl | 16.97 | −10 |
| Methacrylate | | |
| 2-Ethylhexyl Acrylate | 17.03 | −55 |
| n-Hexyl Methacrylate | 17.13 | −5 |
| n-Butyl Methacrylate | 17.22 | 20 |
| n-Hexyl Acrylate | 17.30 | −60 |
| n-Butyl Acrylate | 17.45 | −55 |
| Ethyl Methacrylate | 17.90 | 66 |
| Ethyl Acrylate | 18.04 | −24 |
| Methyl Methacrylate | 18.17 | 105 |
| Vinyl Acetate | 19.40 | 30 |
| Methyl Acrylate | 20.2 | 5 |

Calculated using Small's Group Contribution Method, Small, P. A. Journal of Applied Chemistry 3 p. 71 (1953). Using Group Contributions from Polymer Handbook, 3rd Ed., J. Brandrup E. H. Immergut, Eds., John Wiley, N.Y., p. VII/525 (1989).
Polymer Handbook, 3rd Ed., J. Brandrup E. H. Immergut, Eds., John Wiley, N.Y., pp. VII/209-277 (1989).

The composition of the graft stabilizer is normally selected such that the Hildebrand Solubility Parameter of the graft stabilizer (shell) closely matches that of the carrier liquid to ensure that the stabilizer will be sufficiently solvated to dissolve in the carrier solvent. Virtually any polymerizable compound that exhibits a Hildebrand Solubility Parameter difference less than 3.0 MPa^{1/2} relative to the carrier liquid may be used in forming a graft stabilizer. In addition, polymerizable compounds that exhibit a Hildebrand Solubility Parameter difference greater than 3.0 MPa^{1/2} relative to the carrier liquid may be used in forming a copolymeric graft stabilizer, provided that the effective Hildebrand Solubility Parameter difference between the stabilizer and the carrier liquid is less than 3.0 MPa^{1/2}. The absolute difference in Hildebrand Solubility Parameter between the graft stabilizer (shell) and the carrier liquid is preferably less than 2.6 MPa^{1/2}.

In general, graft stabilizers derived from C₆-C₃₀ acrylates and methacrylates, such as lauryl methacrylate (LMA) and octadecyl acrylate (ODA), are very soluble in hydrocarbon carriers because their Hildebrand Solubility Parameters are close to those of hydrocarbon carriers. Non-limiting examples of suitable C₆-C₃₀ acrylic and methacrylic esters for use in the graft stabilizer composition include hexyl acrylate, 2-ethylhexyl acrylate, decyl acrylate, dodecyl(lauryl) acrylate, octadecyl(stearyl) acrylate, behenyl acrylate, hexyl methacrylate, 2-ethylhexyl(methacrylate), decyl acrylate, dodecyl(lauryl)methacrylate, octadecyl(stearyl)methacrylate, isobornyl acrylate, isobornyl methacrylate, and other acrylates and methacrylates which meet the solubility parameter requirements described above.

The graft stabilizer may be chemically bonded to the resin core (e.g., grafted to the core) or may be adsorbed onto the core such that it remains as a physically bound integral part of the resin core, including fusion to the core. Any number of reactions known to those skilled in the art may be used to effect grafting of the soluble polymeric stabilizer to the organosol core during free radical polymerization. Common grafting methods include random grafting of polyfunctional free radicals; ring-opening polymerizations of cyclic ethers, esters, amides or acetals; epoxidations; reactions of hydroxyl or amino chain transfer agents with terminally-unsaturated end groups; esterification reactions (e.g., glycidyl methacrylate undergoes tertiary-amine catalyzed esterification with methacrylic acid); and condensation reactions or polymerization. Preferred weight average molecular weights of the graft stabilizer are from 50,000 to 1,000,000 Daltons (Da), more preferably from 100,000 to 500,00 Da, most preferably from 100,000 to 300,000 Da.

The polydispersity of the graft stabilizer also has an affect on imaging and transfer performance of the liquid toners. Generally, it is desirable to maintain the polydispersity (the ratio of the weight-average molecular weight to the number average molecular weight) of the graft stabilizer below 15, more preferably below 5, most preferably below 2.5.

The stabilizer is grafted to the insoluble core. The grafting site is formed by incorporating hydroxyl groups into the graft stabilizer during a first free radical polymerization and catalytically reacting all or a portion of these hydroxyl groups with an ethylenically unsaturated aliphatic isocyanate (e.g., meta-isopropenyldimethylbenzyl isocyanate [TMI] or 2-cyanatoethylmethacrylate [IEM] to form a polyurethane linkage during a subsequent non-free radical reaction step. The graft stabilizer is then covalently bonded to the nascent insoluble acrylic (co)polymer core via reaction of the unsaturated vinyl group of the grafting site with ethylenically-unsaturated core monomers (e.g. vinyl esters, particularly acrylic and methacrylic esters with carbon numbers less than 7 or vinyl acetate; vinyl aromatics, such as styrene; acrylonitrile; n-vinyl pyrrolidone; vinyl chloride and vinylidene chloride) during a subsequent free radical polymerization step.

Other methods of effecting grafting of the preformed polymeric stabilizer to the incipient insoluble core particle are known to those skilled in the art. For example, alternative grafting protocols are described in sections 3.7-3.8 of Barrett Dispersion Polymerization in Organic Media, K. E. J. Barrett, ed., (John Wiley: New York, 1975), pp. 79-106. A particularly useful method for grafting the polymeric stabilizer to core utilizes an anchoring group. The function of the anchoring groups is to provide a covalent link between the core part of the particle and the soluble component of the steric stabilizer. Suitable monomers containing anchoring groups include: adducts of alkenylazlactone comonomers with an unsaturated nucleophile containing hydroxy, amino, or mercaptan groups, such as 2-hydroxyethylmethacrylate, 3-hydroxypropylmethacrylate, 2-hydroxyethylacrylate, pentaerythritol triacrylate, 4-hydroxybutyvinylether, 9-octadecen-1-ol, cinnamyl alcohol, allyl mercaptan, methallylamine; and azlactones, such as 2-alkenyl-4,4-dialkylazlactone of the structure 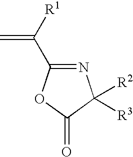
where R¹═H, or alkyl groups having 1 to 5 carbons, preferably one carbon, R² and R³ are independently lower alkyl groups having 1 to 8 carbons, preferably 1 to 4 carbons.

Most preferably, however, the grafting mechanism is accomplished by grafting an ethylenically-unsaturated isocyanate (e.g., dimethyl-m-isopropenyl benzylisocyanate, available from American Cyanamid) to hydroxyl groups previously incorporated into the graft stabilizer precursor (e.g., by use of hydroxy ethyl methacrylate).

The core polymer may be made in situ by copolymerization with the stabilizer monomer. The composition of the insoluble resin core is preferentially manipulated such that the resin core exhibits a low glass transition temperature (Tg) that allows one to formulate an ink composition containing the resin as a major component to undergo rapid film formation (rapid self-fixing) in printing or imaging processes carried out at temperatures greater than the core Tg, preferably at or above 23° C. Rapid self-fixing assists in avoiding printing defects (such as smearing or trailing-edge tailing) and incomplete transfer in high speed printing.

Non-limiting examples of polymerizable organic compounds suitable for use in the organosol core include monomers such as, methyl acrylate, ethyl acrylate, butyl acrylate, methyl(methacrylate), ethyl(methacrylate), butyl(methacrylate), and other acrylates and methacrylates, most preferred being methylmethacrylate and ethylacrylate.

To form a stable ink dispersion, the organosol particles should have the ability to interact strongly with the colorant pigment particles. This requires that organosol particles contain moieties that can either chemical bond to or physical adsorb onto the pigment surface. Organosols containing amine groups or acid groups can promote the interaction between the organosol and the pigment and thus stabilize the ink dispersion. Such organosols can be prepared by incorporating polymerizable organic compounds containing acid or amine groups into either the thermoplastic (co)polymeric core or the (co)polymeric steric stabilizer by copolymerizing such polymerizable organic compounds with other conventional monomers for either the thermoplastic (co)polymeric core or the (co)polymeric steric stabilizer accordingly.

Non-limiting examples of polymerizable organic compounds having at least an acid group are 4-vinylbenzoic acid, fumaric acid, cinnamic acid, sorbic acid, mesaconic acid, maleic acid, glutaconic acid, citraconic acid, itaconic acid, indene-3-carboxylic acid, and alpha-beta unsaturated alkenoic acids such as acrylic acid, methacrylic acid, crotonic acid, 2-methacryloyloxyethyl hydrogen phthalate, 4-methacrylamidobenzoic acid, mono-(2-methacryloyloxyethyl)-succinic acid, and 2-methyl-2-pentenoic acid. The preferred polymerizable organic compounds having at least an acid group are acrylic acid and methacrylic acid.

Non-limiting examples of polymerizable organic compounds having at least an amine group are selected from the group consisting of (meth)acrylates having aliphatic amino radicals such as N,N-dimethylaminoethyl(meth)acrylate, N,N-diethylaminoethyl(meth)acrylate, N,N-dibutylaminoethyl(meth)acrylate, N,N-hydroxyethylaminoethyl(meth)acrylate, N-benzyl,N-ethylaminoethyl(meth)acrylate, N,N-dibenzylaminoethyl(meth)acrylate, N-octyl,N,N-dihexylaminoethyl(meth)acrylate and the like; nitrogen-containing heterocyclic vinyl monomers such as N-vinylimidazole, N-vinylindazole, N-vinyltetrazole, 2-vinylpyridine, 4-vinylpyridine, 2-methyl-5-vinylpyridine, 2-vinylquinoline, 4-vinylquinoline, 2-vinylpyrazine, 2-vinyloxazole, 2-vinylbenzooxazole and the like; N-vinyl substituted ring-like amide monomers such as N-vinylpyrrolidone, N-vinylpiperidone, N-vinyloxazolidone and the like; (meth)acrylamides such as N-methylacrylamide, N-octylacrylamide, N-phenylmethacrylamide, N-cyclohexylacrylamide, N-phenylethylacrylamide, N-p-methoxy-phenylacrylamide, acrylamide, N,N-dimethylacrylamide, N,N-dibutylacrylamide, N-methyl,N-phenylacrylamide, piperidine acrylate, morpholine acrylate and the like; aromatic substituted ethylene monomers containing amino radicals such as dimethlaminostyrene, diethylaminostyrene, diethylaminomethylstyrene, dioctylaminostyrene and the like; and nitrogen-containing vinylether monomers such as vinyl-N-ethyl-N-phenylaminoethylether, vinyl-N-butyl-N-phenylaminoethylether, triethanolamine divinylether, vinyldiphenylaminoethylether, vinypyrrolizylaminoether, vinyl-beta-morpholinoethylether, N-vinylhydroxyethylbenzamide, m-aminophenylvinylether and the like. The preferred polymerizable organic compounds having at least an amine group are N,N-dimethylaminoethyl(meth)acrylate and N,N-diethylaminoethyl(meth)acrylate.

Other polymers which may be used either alone or in conjunction with the aforementioned materials, include melamine and melamine formaldehyde resins, phenol formaldehyde resins, epoxy resins, polyester resins, styrene and styrene/acrylic copolymers, vinyl acetate and vinyl acetate/acrylic copolymers, acrylic and methacrylic esters, cellulose acetate and cellulose acetate-butyrate copolymers, and poly(vinyl butyral) copolymers.

The optimal weight ratio of the resin core to the stabilizer shell is on the order of 1/1 to 15/1, preferably between 2/1 and 10/1, and most preferably between 4/1 and 8/1. Undesirable effects may accompany core/shell ratios selected outside of these ranges. For example, at high core/shell ratios (above 15), there may be insufficient graft stabilizer present to sterically-stabilize the organosol with respect to aggregation. At low core/shell ratios (below 1), the polymerization may have insufficient driving force to form a distinct particulate phase resulting in a copolymer solution, not a self-stable organosol dispersion.

The particle size of the organosols also influences the imaging, drying and transfer characteristics of the liquid inks. Preferably, the primary particle size (determined with dynamic light scattering) of the organosol is between about 0.05 and 5.0 microns, more preferably between 0.15 and 1 micron, most preferably between 0.20 and 0.50 microns.

Any number of methods may be used for effecting particle size reduction of the pigment in preparation of the gel liquid toners. Some suitable methods include high shear homogenization, ball-milling, attritor milling, high energy bead (sand) milling or other means known in the art.

A liquid ink utilizing the aforementioned organosol comprises colorant particles embedded in the thermoplastic organosol resin. Useful colorants are well known in the art and include materials such as dyes, stains, and pigments. Preferred colorants are pigments that may be incorporated into the polymer resin, are nominally insoluble in and nonreactive with the carrier liquid, and are useful and effective in making visible the latent electrostatic image. Non-limiting examples of typically suitable colorants include: phthalocyanine blue (C.I. Pigment Blue 15:1, 15:2, 15:3 and 15:4), monoarylide yellow (C.I. Pigment Yellow 1, 3, 65, 73 and 74), diarylide yellow (C.I. Pigment Yellow 12, 13, 14, 17 and 83), arylamide (Hansa) yellow (C.I. Pigment Yellow 10, 97, 105, 138 and 111), azo red (C.I. Pigment Red 3, 17, 22, 23, 38, 48:1, 48:2, 52:1, 81, 81:4 and 179), quinacridone magenta (C.I. Pigment Red 122, 202 and 209) and black pigments such as finely divided carbon (Cabot Monarch 120, Cabot Regal 300R, Cabot Regal 350R, Vulcan X72) and the like. In one embodiment of the invention, the colorant is a pigment selected to have at least one surface acid or base group. The surface acid or base group may be part of the pigment molecular structure or may by part of a separate molecule adsorbed to the pigment surface using well-known pigment surface treatment methods. Preferred pigments having surface acid groups include Pigment Blue 15:1, 15:2, 15:3 and 15:4; Acid Blue Pigments and surface acid carbon blacks such as Cabot Mogul L. Preferred pigments having base groups include Pigment Red 81:1, 81:2, 81:3, and 81:4; and surface treated carbon blacks such as Aztech BK8200 and EK8200. The Cabot carbon blacks are identified in the literature as having acid surfaces because of chemisorbed groups and have an acidic pH (e.g., of 2-4).

The optimal weight ratio of resin to colorant in the toner particles is on the order of 1/1 to 20/1, preferably between 3/1 and 10/1 and most preferably between 5/1 and 8/1. The total dispersed material in the carrier liquid typically represents 0.5 to 70 weight percent, preferably between 1 and 25 weight percent, most preferably between 2 and 12 weight percent of the total liquid developer composition.

An electrophotographic liquid toner may be formulated by incorporating a functional dispersant into the liquid ink. The dispersant may be a polymer which has a high affinity to both the toner particles and to the carrier liquid. It either completely or partially dissolves in the carrier liquid or swells with the carrier liquid.

These polymers are not specifically limited to, but may include polyolefins, polyvinyl alcohol, polyvinyl methylether, polyvinyl ethylether, polyethylene oxide, gelatine, methyl cellulose, methylhydroxypropyl cellulose, ethyl cellulose, sodium salts of carboxymethyl cellulose, starch, polymers having at least an acid group, and polymers having at least an amine group. The preferred dispersants are polymers having at least an acid group and polymers having at least an amine group.

Non-limiting examples of dispersants having at least an acid group are polyacrylic acid and hydrocarbon soluble copolymers thereof; polymethacrylic acid and hydrocarbon soluble copolymers thereof; polystyrenesulfonic acid and hydrocarbon soluble copolymers thereof; polyvinylsulfonic acid and hydrocarbon soluble copolymers thereof; styrene/maleic acid copolymers and hydrocarbon soluble derivatives thereof; and vinyl methyl ether/maleic acid copolymers and hydrocarbon soluble derivatives thereof. All dispersant preferably have, but do not necessarily require, weight average molecular weights of 1,000 to 100,000. The preferred acidic polymeric dispersants are hydrocarbon soluble copolymers comprising acrylic acid, methacrylic acid, or their combinations, such as Solsperse™ 28000 (commercially available from Avecia Pigments and Additives Group, Charlotte, N.C.).

Non-limiting examples of dispersants having at least an amine group are polyvinyl pyrrolidone, polyamine, polyethyleneimine, poly(meth)acrylates containing amine groups, copolymers of alkyl (meth)acrylate and (meth)acrylates containing amine groups, and their hydrocarbon soluble derivatives. The preferred dispersants having at least an amine group for this invention are hydrocarbon soluble copolymers derived from tertiary amine monomers such as dimethylaminoethyl methacrylate such as Solsperse 13940 (commercially obtained from Avecia Pigments and Additives Group, Charlotte, N.C.) and Disperbyk™ 116 (commercially obtained from Byk Chemie—USA, Inc., Wallingford, Conn.).

The dispersant is preferably added to the carrier liquid at the rate from 0.01% to 20% by weight for improving the dispersibility and preventing rise in viscosity of the carrier liquid due to addition of the dispersant. More preferably, the rate is substantially in a range from 0.1% to 10% by weight.

A rate of the total weight of the solid components such as the toner, charge director and dispersant with respect to the total weight of the liquid developer is preferably in a range from about 1% to 90% by weight. For the purpose of reducing the total amount of the liquid developer used for the developing, and thereby facilitating the handling, the total rate of the solid components is more preferably in a range from 2% to 50% by weight.

An electrophotographic liquid toner may be formulated by incorporating a charge control agent into the liquid ink. The charge control agent, also known as a charge director, provides improved uniform charge polarity of the toner particles. The charge director may be incorporated into the toner particles using a variety of methods, such as chemically reacting the charge director with the toner particle, chemically or physically adsorbing the charge director onto the toner particle (resin or pigment), or chelating the charge director to a functional group incorporated into the toner particle. A preferred method is attachment via a functional group built into the graft copolymer binder. The charge director acts to impart an electrical charge of selected polarity onto the toner particles. Any number of charge directors described in the art may be used. Preferred charge directors are positively charging, i.e., they produce positive polarity charged toner particles dispersed in the carrier liquid.

For example, the charge director may be organic acid metal salts consisting of polyvalent metal ions and organic anions as the counterion. Non-limiting examples of suitable metal ions include Ba(II), Ca(II), Mn(II), Zn(II), Zr(IV), Cu(II), Al(III), Cr(III), Fe(II), Fe(III), Sb(III), Bi(III), Co(II), La(III), Pb(II), Mg(II), Mo(III), Ni(II), Ag(I), Sr(II), Sn(IV), V(V), Y(III), and Ti(IV). Non-limiting examples of suitable organic anions include carboxylates or sulfonates derived from aliphatic or aromatic carboxylic or sulfonic acids, preferably aliphatic fatty acids such as stearic acid, behenic acid, neodecanoic acid, diisopropylsalicylic acid, abietic acid, naphthenic acid, octanoic acid, lauric acid, tallic acid, and the like. Preferred positive charge directors are the metallic carboxylates (soaps) described in U.S. Pat. No. 3,411,936, incorporated herein by reference, which include alkaline earth- and heavy-metallic salts of fatty acids containing at least 6-7 carbons and cyclic aliphatic acids including naphthenic acid; more preferred are polyvalent metal soaps of zirconium and aluminum; most preferred is the zirconium soap of octanoic acid (Zirconium HEX-CEM from Mooney Chemicals, Cleveland, Ohio).

The conventional charge director for negative charged inks may also be used. Non-limiting examples of suitable negative charge directors are polymers or copolymers having nitrogen-containing monomer, quaternary ammonium block copolymers, lecithin, basic metallic petronates such as basic barium petronate, basic calcium petronate, and basic sodium petronate, metal naphthenate compounds, and polyisobutylene succinimide available as OLOA 1200 from Chevron Oronite Company LLC, Houston, Tex., and the like. Specific examples for the nitrogen-containing monomer are (meth)acrylates having an aliphatic amino group, vinyl monomers having nitrogen-containing heterocyclic ring, cyclic amide monomers having N-vinyl substituent, (meth)acrylamides, aromatic substituted ethlylenic monomers having nitrogen-containing group, nitrogen-containing vinyl ether monomers, etc. Particularly preferable is a copolymer which is soluble in a hydrocarbon carrier liquid and containing a monomer such as hexyl(meth)acrylate, cyclohexyl(meth)acrylate, 2-ethylhexyl(meth)acrylate, octyl(meth)acrylate, nonyl(meth)acrylate, decyl(meth)acrylate, dodecyl(meth)acrylate, lauryl(meth)acrylate, stearyl(meth)acrylate, vinyl laurate, vinyl stearate, benzyl(meth)acrylate and pheny(meth)acrylate. Preferred negative charge directors are lecithin, basic metallic petronate, and polyisobutylene succinimide.

The preferred charge direction levels for a given toner formulation will depend upon a number of factors, including the composition of the graft stabilizer and organosol, the molecular weight of the organosol, the particle size of the organosol, the core/shell ratio of the graft stabilizer, the pigment used in making the toner, and the ratio of organosol to pigment. In addition, preferred charge direction levels will also depend upon the nature of the electrophotographic imaging process, particularly the design of the developing hardware and photoreceptive element. Those skilled in the art, however, know how to adjust the level of charge direction based on the listed parameters to achieve the desired results for their particular application. Typical charge director levels are generally between 1-1000 mg charge director per gram of toner solids, more preferably 1-100 mg/g.

A liquid toner comprising a carrier liquid, a binder, a dispersant, a charge director, and a colorant can be formulated in various ways. This invention discovers that a positive liquid toner comprising an organosol having acid groups, preferably with an acid value greater than 10 mg KOH/g, a dispersant having amine groups such that the mole ratio of the amine groups to the acid groups is between 0.3 and 1.5, and an organic acid metal salt charge director possesses unexpected dispersion stability and chargeability. Furthermore, a negative liquid toner comprising an organosol having amine groups, a dispersant having acid groups such that the mole ratio of the acid groups to the amine groups is between 0.3 and 1.5, and a nitrogen-containing charge director has unexpected dispersion stability and chargeability.

The acid value can be measured by a method according to JIS (Japanese Industrial Standard) K0070. Specifically, the dispersant polymer is dissolved in a 1:1 or 2:1 mixed solution of diethyl ether with either 99.5% ethanol or isopropyl alcohol, and then phenolphthalein is added thereinto as an indicator. Titration is then carried out using a 0.1 mol/liter solution of potassium hydroxide in ethanol. The amount of the dispersant polymer, which is a sample, is 20 g, 10 g, 5 g, 2 g and 1 g in the case wherein the acid value is less than 5, not less than 5 and less than 15, not less than 15 and less than 30, not less than 30 and less than 100, and 100 or more, respectively. The acid value is calculated by using the value from the titration and the following equation:
Acid value=B×F×5.611/S,
wherein B represents the amount (ml) of the 0.1 mol/liter solution of potassium hydroxide in ethanol which is required for the titration, F represents a factor of the 0.1 mol/liter solution of potassium hydroxide in ethanol, and S represents the weight (g) of a sample.

The amine value can be measured by a method according to JIS K 7237. Specifically, 8.5 ml of perchloric acid is added into a solution wherein 500 ml of acetic acid is beforehand mixed with 30 ml of acetic anhydride, and then mixed. Further, acetic acid is added into this mixture so that the total amount is 1000 ml. This mixture is permitted to stand a whole day and night to obtain a titrating solution. 100 ml of a solution of a mixture of 900 ml of o-nitrotoluene and 200 ml of acetic acid is added into a sample corresponding to 2-3 mmols of basic nitrogen, and then dissolved therein. Several drops of a 0.1 g/100 ml solution of Crystal Violet in acetic acid are then added into this mixture. Subsequently, titration is carried out by using the aforementioned perchloric acid until the blue color starts to turn greenish. The amine value is calculated by using the value from this titration and the following equation:
Amine value=56.11×0.1×(V₃-V₄)×F/M₂,
wherein V₃ represents the amount (ml) of the 0.1 mol/liter perchloric acid solution which is required for the titration, V₄ represents the amount (ml) of the 0.1 mol/liter perchloric acid solution which is required for a blank test, F represents the factor of the 0.1 mol/liter perchloric acid solution, and M₂ represents the weight (g) of a sample.

The conductivity of a liquid toner has been well established in the art as a measure of the effectiveness of a toner in developing electrophotographic images. The useful conductivity range is from about 1×10⁻¹¹ mho/cm to 10×10⁻¹⁰ mho/cm. High conductivities generally indicate inefficient association of the charges on the toner particles and is seen in the low relationship between current density and toner deposited during development. Low conductivities indicate little or no charging of the toner particles and lead to very low development rates. The use of charge director compounds to ensure sufficient charge associated with each particle is a common practice. There has, in recent times, been a realization that even with the use of charge directors there can be much unwanted charge situated on charged species in solution in the carrier liquid. Such unwanted charge produces inefficiency, instability and inconsistency in the development.

Suitable efforts to localize the charges onto the toner particles and to ensure that there is substantially no migration of charge from those particles into the liquid, and that no other unwanted charge moieties are present in the liquid, give substantial improvements. As a measure of the required properties, we use the ratio between the conductivity of the carrier liquid as it appears in the liquid toner and the conductivity of the liquid toner as a whole (the completely constituted toner dispersion). This ratio should be less than 0.6 preferably less than 0.4 and most preferably less than 0.3. Many prior art toners examined have shown ratios much larger than this, in the region of a ratio of 0.95.

In electrophotography, the electrostatic image is typically formed on a sheet, drum or belt coated with a photoreceptive element by (1) uniformly charging the photoreceptive element with an applied voltage, (2) exposing and discharging portions of the photoreceptive element with a radiation source to form a latent image, (3) applying a toner to the latent image to form a toned image, and (4) transferring the toned image through one or more steps to a final receptor sheet. In some applications, it may be desirable to fix the toned image using a heated pressure roller or other fixing methods known in the art.

While the electrostatic charge of either the toner particles or photoreceptive element may be either positive or negative, electrophotography as employed in the present invention is preferably carried out by dissipating charge on a positively charged photoreceptive element. A positively-charged toner is then applied to the regions in which the positive charge was dissipated using a liquid toner immersion development technique. This development may be accomplished by using a uniform electric field produced by a development electrode spaced near the photoreceptive element surface. A bias voltage is applied to the electrode intermediate to the initially charged surface voltage and the exposed surface voltage level. The voltage is adjusted to obtain the required maximum density level and tone reproduction scale for halftone dots without any background deposited. Liquid toner is then caused to flow between the electrode and the photoreceptive element. The charged toner particles are mobile in the field and are attracted to the discharged areas on the photoreceptive element while being repelled from the undischarged, non-image areas. Excess liquid toner remaining on the photoreceptive element is removed by techniques well known in the art. Thereafter, the photoreceptive element surface may be force dried or allowed to dry at ambient conditions.

The substrate for receiving the image from the photoreceptive element can be any commonly used receptor material, such as paper, coated paper, polymeric films and primed or coated polymeric films. Specially coated or treated metal or metallized surfaces may also be used as receptors. Polymeric films include plasticized and compounded polyvinyl chloride (PVC), acrylics, polyurethanes, polyethylene/acrylic acid copolymer, and polyvinyl butyrals. Commercially available composite materials such as those having the trade designations Scotchcal™, Scotchlite™, and Panaflex™ film materials are also suitable for preparing substrates.

The transfer of the formed image from the charged surface to the final receptor or transfer medium may be enhanced by the incorporation of a release-promoting material within the dispersed particles used to form the image. The incorporation of a silicone-containing material or a fluorine-containing material in the outer (shell) layer of the particle facilitates the efficient transfer of the image.

In multicolor imaging, the toners may be applied to the surface of the dielectric element or photoreceptive element in any order, but for colorimetric reasons, bearing in mind the inversion that occurs on transfer, it is sometimes preferred to apply the images in a specified order depending upon the transparency and intensity of the colors. A preferred order for a direct imaging or a double transfer process is yellow, magenta, cyan and black; for a single transfer process, the preferred order is black, cyan, magenta and yellow. Yellow is generally imaged first on the photoconductor to avoid contamination from other toners and to be the topmost color layer when transferred. Black is generally imaged last on the photoconductor due to the black toner acting as a filter of the radiation source and to be the bottom-most layer after transfer.

In order to function most effectively, liquid toners should have conductance values in the range of 10 to 400 picomho-cm⁻¹. Liquid toners prepared according to the present invention have conductance values of from 20 to 300 picomho-cm⁻¹ for a dispersion containing 2.5% by weight solids.

Overcoating of the transferred image may optionally be carried out to protect the image from physical damage and/or actinic damage. Compositions for overcoatings are well known in the art and typically comprise a clear film-forming polymer dissolved or suspended in a volatile solvent. An ultraviolet light absorbing agent may optionally be added to the coating composition. Lamination of protective layers to the image-beating surface is also well known in the art and may be used with this invention.

These and other aspects of the present invention are demonstrated in the illustrative examples that follow. These examples are to be viewed as illustrative of specific materials falling within the broader disclosure presented above and are not to be viewed as limiting the broader disclosure.

### EXAMPLES

Glossary of Chemical Abbreviations & Chemical Sources

The following abbreviations are used in the examples that follow:
DBTDL: Dibutyl tin dilaurate (a catalyst available from Aldrich Chemical Co., Milwaukee, Wis.)
DMAEMA: 2-Dimethylaminoethyl methacrylate (available from Aldrich Chemical Co., Milwaukee, Wis.)
EMA: Ethyl methacrylate (available from Aldrich Chemical Co., Milwaukee, Wis.)
HEMA: 2-Hydroxyethyl methacrylate (available from Aldrich Chemical Co., Milwaukee, Wis.)
LMA: Lauryl methacrylate (available from Aldrich Chemical Co., Milwaukee, Wis.)
MMA: Methyl methacrylate (available from Aldrich Chemical Co., Milwaukee, Wis.)
TCHMA: Trimethyl cyclohexyl methacrylate (available from Ciba Specialty Chemical Co., Suffolk, Va.)
TMI: Dimethyl-m-isopropenyl benzyl isocyanate (available from CYTEC Industries, West Paterson, N.J.)
V-601: Dimethyl 2,2′-azobisisobutyrate (an initiator available as V-601 from WAKO Chemicals U.S.A., Richmond, Va.)
Zirconium HEX-CEM: (metal soap, zirconium tetraoctoate, available from OMG Chemical Company, Cleveland, Ohio)
   Test Methods

Percent Solids

In the following toner composition examples, percent solids of the graft stabilizer solutions and the organosol and liquid toner dispersions were determined thermo-gravimetrically by drying in an aluminum weighing pan an originally-weighed sample at 160° C. for two hours for graft stabilizer, three hours for organosol, and two hours for liquid toner dispersions, weighing the dried sample, and calculating the percentage ratio of the dried sample weight to the original sample weight, after accounting for the weight of the aluminum weighing pan. Approximately two grams of sample were used in each determination of percent solids using this thermo-gravimetric method.

Molecular Weight

In the practice of the invention, molecular weight is normally expressed in terms of the weight average molecular weight, while molecular weight polydispersity is given by the ratio of the weight average molecular weight to the number average molecular weight. Molecular weight parameters were determined with gel permeation chromatography (GPC) using a Hewlett Packard Series II 1190 Liquid Chromatograph made by Agilent Industries (formerly Hewlett Packard, Palo Alto, Calif.) (using software HPLC Chemstation Rev A.02.02 1991-1993 395). Tetrahydrofuran was used as the carrier solvent. The three columns used in the Liquid Chromatograph were Jordi Gel Columns (DVB 1000A, and DVB10000A and DVB100000A; Jordi Associates, Inc., Bellingham, Mass.). Absolute weight average molecular weight were determined using a Dawn DSP-F light scattering detector (software by Astra v.4.73.04 1994-1999) (Wyatt Technology Corp., Santa Barbara, Calif.), while polydispersity was evaluated by ratioing the measured weight average molecular weight to a value of number average molecular weight determined with an Optilab DSP Interferometric refractometer detector (Wyatt Technology Corp., Santa Barbara, Calif.).

Particle Size

The organosol (and liquid ink) particle size distributions were determined using a Horiba LA-920 laser diffraction particle size analyzer (commercially obtained from Horiba Instruments, Inc, Irvine, Calif.) using Norpar™ 12 fluid that contains 0.1% Aerosol OT (dioctyl sodium sulfosuccinate, sodium salt, Fisher Scientific, Fairlawn, N.J.) surfactant.

Prior to the measurements, samples were pre-diluted to approximately 1% by the solvent (i.e., Norpar 12™). Liquid toner samples are were sonicated for 6 minutes in a Probe VirSonic sonicator (Model-550 by The VirTis Company, Inc., Gardiner, N.Y.). The samples were diluted by approximately 1/500 by volume prior to sonication. Sonication on the Horiba LA-920 was operated at 150 watts and 20 kHz. The particle size was expressed on a number-average basis in order to provide an indication of dominance of the fundamental (primary) particle size of the particles or was expressed on a volume-average basis in order to provide an indication of dominance of the coalesced primary particle aggregate size of the particles.

Glass Transition Temperature

Thermal transition data for synthesized TM was collected using a TA Instruments Model 2929 Differential Scanning Calorimeter (DSC) (New Castle, Del.) equipped with a DSC refrigerated cooling system (−70° C. minimum temperature limit), and dry helium and nitrogen exchange gases. The calorimeter ran on a Thermal Analyst 2100 workstation with version 8.10B software. An empty aluminium pan was used as the reference. The samples were prepared by placing 6.0 to 12.0 mg of the experimental material into an aluminum sample pan and crimping the upper lid to produce a hermetically sealed sample for DSC testing. The results were normalized on a per mass basis. Each sample was evaluated using 10° C./min heating and cooling rates with a 5-10 min isothermal bath at the end of each heating or cooling ramp. The experimental materials were heated five times: the first heat ramp removes the previous thermal history of the sample and replaces it with the 10° C./min cooling treatment and subsequent heat ramps are used to obtain a stable glass transition temperature value—values are reported from either the third or fourth heat ramp.

Conductivity

The liquid toner conductivity (bulk conductivity, k_{b}) was determined at approximately 18 Hz using a Scientifica Model 627 conductivity meter (Scientifica Instruments, Inc., Princeton, N.J.). In addition, the free (liquid dispersant) phase conductivity (k_{f}) in the absence of toner particles was also determined. Toner particles were removed from the liquid medium by centrifugation at 10° C. for 1 hour at 7,500 rpm (6,110 relative centrifugal force) in a Jouan MR1822 centrifuge (Winchester, Va.). The supernatant liquid was then carefully decanted, and the conductivity of this liquid was measured using a Scientifica Model 627 conductance meter. The percentage of free phase conductivity relative to the bulk toner conductivity was then determined as 100% (k_{f}/k_{b}).

Mobility

Toner particle electrophoretic mobility (dynamic mobility) was measured using a Matec MBS-8000 Electrokinetic Sonic Amplitude Analyzer (Matec Applied Sciences, Inc., Hopkinton, Mass.). Unlike electrokinetic measurements based upon microelectro-phoresis, the MBS-8000 instrument has the advantage of requiring no dilution of the toner sample in order to obtain the mobility value. Thus, it was possible to measure toner particle dynamic mobility at solids concentrations actually preferred in printing. The MBS-8000 measures the response of charged particles to high frequency (1.2 MHz) alternating (AC) electric fields. In a high frequency AC electric field, the relative motion between charged toner particles and the surrounding dispersion medium (including counter-ions) generates an ultrasonic wave at the same frequency of the applied electric field. The amplitude of this ultrasonic wave at 1.2 MHz can be measured using a piezoelectric quartz transducer; this electrokinetic sonic amplitude (ESA) is directly proportional to the low field AC electrophoretic mobility of the particles. The particle zeta potential can then be computed by the instrument from the measured dynamic mobility and the known toner particle size, liquid dispersant viscosity, and liquid dielectric constant.

Q/M

The charge per mass measurement (Q/M) was measured using an apparatus that consists of a conductive metal plate, a glass plate coated with Indium Tin Oxide (ITO), a high voltage power supply, an electrometer, and a personal computer (PC) for data acquisition. A 1% solution of ink was placed between the conductive plate and the ITO coated glass plate. An electrical potential of known polarity and magnitude was applied between the ITO coated glass plate and the metal plate, generating a current flow between the plates and through wires connected to the high voltage power supply. The electrical current was measured 100 times a second for 20 seconds and recorded using the PC. The applied potential causes the charged toner particles to migrate towards the plate (electrode) having opposite polarity to that of the charged toner particles. By controlling the polarity of the voltage applied to the ITO coated glass plate, the toner particles may be made to migrate to that plate.

The ITO coated glass plate was removed from the apparatus and placed in an oven for approximately 1 hour at 160° C. to dry the plated ink completely. After drying, the ITO coated glass plate containing the dried ink film was weighed. The ink was then removed from the ITO coated glass plate using a cloth wipe impregnated with Norpar™ 12, and the clean ITO glass plate was weighed again. The difference in mass between the dry ink coated glass plate and the clean glass plate is taken as the mass of ink particles (m) deposited during the 20 second plating time. The electrical current values were used to obtain the total charge carried by the toner particles (Q) over the 20 seconds of plating time by integrating the area under a plot of current vs. time using a curve-fitting program (e.g. TableCurve 2D from Systat Software Inc.). The charge per mass (Q/m) was then determined by dividing the total charge carried by the toner particles by the dry plated ink mass.

Viscosity

The viscosity of liquid inks is measured using a Brookfield LV Viscometer (available from Brookfield Inc., Middleboro, Mass.). Ink samples were removed from oven and were untouched for 6 hours at room temperature. Samples were then hand mixed and placed on shaker for 30 minutes. For viscosities under 1000 centipoise, spindle 1 was used; for viscosities over 1000 centipoise, spindle 2 was used.

Print Testing

In the following examples, toner was printed onto final image receptors using the following methodology:

A light-sensitive temporary image receptor (organic photoreceptor or “OPC”) was charged with a uniform positive charge of approximately 850 volts. The positively charged surface of the OPC was image-wise irradiated with a scanning infrared laser module in order to reduce the charge wherever the laser struck the surface. Typical charge-reduced values were between 50 volts and 100 volts.

A developer apparatus was then utilized to apply the toner particles to the OPC surface. The developer apparatus included the following elements: liquid toner, a conductive rubber developer roller in contact with the OPC, an insulative foam cleaning roller in contact with the developer roller surface, a conductive deposition roller, a conductive metering roll in contact with the developer roller, and an insulative foam ink pumping roller. The contact area between the developer roller and the OPC is referred to as the “developing nip.” The conductive deposition roller was positioned with its roller axis parallel to the developer roller axis and its surface arranged to be approximately 150 microns from the surface of the developer roller, thereby forming a deposition gap.

During development, the ink pumping roller supplied liquid ink to the gap between the deposition roller and the developer roller. A toner film was initially plated to the developer roller surface by applying a voltage of approximately 600 volts to the developer roller and applying a voltage of approximately 800 volts to both the deposition and metering rollers. The 200 volt difference between the developer and deposition roller caused the positively charged toner particles to migrate in the deposition nip to the surface of the developer roller. The metering roller, which is biased to approximately 800 volts, removed excess liquid from the developer roller surface.

The surface of the developer roller now contained a uniformly thick layer of toner at approximately 25% (w/w) solids. As this toner layer passed through the developing nip, toner was transferred from the developer roller to the latent image areas. The approximate 500 volt difference between the developer roller and the latent image area caused the positively charged toner particles to develop to the OPC surface. At the exit of the developing nip, the OPC contained a toner image and the developer roller contained a negative of that toner image which was then cleaned from the developer roller surface by the rotating foam cleaning roller.

The developed image on the OPC was subsequently electrostatically transferred to an Intermediate Transfer Belt (ITB) with an electrical bias in the range of −800 to −2000 volts applied to a conductive rubber roller pressing the ITB to the OPC surface. Transfer to the final image receptor was accomplished with electrostatically-assisted offset transfer by forcibly applying a conductive, biased rubber transfer roller behind the image receptor, pressing the imaged ITB between the final image receptor and a grounded, conductive metal transfer backup roller. The transfer roller is typically biased in the range of −1200 to −3000 volts.

### EXAMPLES

### Nomenclature

In the following examples, the compositional details of each copolymer will be summarized by ratioing the weight percentages of monomers used to create the copolymer. The grafting site composition is expressed as a weight percentage of the monomers comprising the copolymer or copolymer precursor, as the case may be. For example, a graft stabilizer (precursor to the S portion of the copolymer) designated TCHMA/HEMA-TMI (97/3-4.7) is made by copolymerizing, on a relative basis, 97 parts by weight TCHMA and 3 parts by weight HEMA, and this hydroxy functional polymer was reacted with 4.7 parts by weight of TMI.

Similarly, a graft copolymer organosol designated TCHMA/HEMA-TMI//EMA (97/3-4.7//100) is made by copolymerizing the designated graft stabilizer (TCHMA/HEMA-TMI (97/3-4.7)) (S portion or shell) with the designated core monomer EMA (D portion or core, 100% EMA) at a specified ratio of D/S (core/shell) determined by the relative weights reported in the examples.

Graft Stabilizer Preparation

### Example 1

### TCHMA/HEMA-TMI (97/3-4.7)

A 190 liter (50 gallon) reactor, equipped with a condenser, a thermocouple connected to a digital temperature controller, a nitrogen inlet tube connected to a source of dry nitrogen and a mixer, was thoroughly cleaned with a heptane reflux and then thoroughly dried at 100° C. under vacuum. A nitrogen blanket was applied and the reactor was allowed to cool to ambient temperature. The reactor was charged with 88.48 kg (195 lbs) of Norpar™12, by vacuum. The vacuum was then broken and a flow of 1 CFH (cubic foot per hour) of nitrogen applied and the agitation is started at 70 RPM. 30.12 kg (66.4 lbs) of TCHMA was added and the container rinsed with 1.23 kg (2.7 lbs) of Norpar™ 12. 0.95 kg (2.10 lbs) of 98% (w/w) HEMA was added and the container rinsed with 0.62 kg (1.37 lbs) of Norpar™ 12. Finally 0.39 kg (0.86 lb) of V-601 was added and the container rinsed with 0.09 kg (0.2 lb) of Norpar™ 12. A full vacuum was then applied for 10 minutes, and then broken by a nitrogen blanket. A second vacuum was pulled for 10 minutes, and then agitation stopped to verify that no bubbles were coming out of the solution. The vacuum was then broken with a nitrogen blanket and a light flow of nitrogen of 1 CFH was applied. Agitation was resumed at 75 RPM and the mixture was heated to 75° C. and held for 4 hours. The conversion was quantitative.

The mixture was heated to 100° C. and held at that temperature for 1 hour to destroy any residual V-601, and then was cooled back to 70° C. The nitrogen inlet tube was then removed, and 0.050 kg (0.11 lb) of 95% (w/w) DBTDL was added to the mixture using 0.62 kg (1.37 lbs) of Norpar™ 12 to rinse container, followed by 1.47 kg (3.23 lbs) of TMI. The TMI was added drop wise over the course of approximately 5 minutes while stirring the reaction mixture and the container was rinsed with 0.64 kg (1.4 lbs.) of Norpar™ 12. The mixture was allowed to react at 70° C. for 2 hours, at which time the conversion was quantitative.

The mixture was then cooled to room temperature. The cooled mixture was a viscous, transparent liquid containing no visible insoluble matter. The percent solids of the liquid mixture were determined to be 26.2% (w/w) using the thermogravimetric method described above. Subsequent determination of molecular weight was made using the GPC method described above; the copolymer had a M_{w} of 270,800 and M_{w}/Mₙ of 2.58 based on two independent measurements. The product is a copolymer of TCHMA and HEMA containing random side chains of TMI and is designated herein as TCHMA/HEMA-TMI (97/3-4.7% w/w) and can be used to make an organosol.

Dispersant Preparations

Graft Dispersants

### Example 2

### TCHMA/HEMA-TMI/MAA (96.4/3.1-4.7/0.5)

A 5000 ml, 3-neck round flask equipped with a condenser, a thermocouple connected to a digital temperature controller, a nitrogen inlet tube connected to a source of dry nitrogen and a mechanical stirrer, was charged with a mixture of 2561 g of Norpar™ 12, 844.5 g of TCHMA, 4.4 g of MAA, 26.8 g of 98% (w/w) HEMA and 8.75 g of V-601. While stirring the mixture, the reaction flask was purged with dry nitrogen for 30 minutes at flow rate of approximately 2 liters/minute. A hollow glass stopper was inserted into the open end of the condenser and the nitrogen flow rate was reduced to approximately 0.5 liters/minute. The mixture was heated to 70° C. for 16 hours. The conversion was quantitative.

The mixture was then heated to 90° C. and held at that temperature for 1 hour to destroy any residual V-601, and then was cooled back to 70° C. The nitrogen inlet tube was then removed and 13.6 g of 95% (w/w) DBTDL were added to the mixture. Next 41.1 g of TMI was added drop wise over the course of approximately 5 minutes while stirring the reaction mixture. The nitrogen inlet tube was replaced, the hollow glass stopper in the condenser was removed, and the reaction flask was purged with dry nitrogen for 30 minutes at a flow rate of approximately 2 liters/minute. The hollow glass stopper was reinserted into the open end of the condenser and the nitrogen flow rate was reduced to approximately 0.5 liters/min. The mixture was allowed to react at 70° C. for 6 hours, at which time the conversion was quantitative.

The mixture was then cooled to room temperature to produce a viscous, transparent liquid containing no visible insoluble mater. The percent solids of the liquid mixture was determined to be 26.5% (w/w) using the thermogravimetric method described above. Subsequent determination of molecular weight was made using the GPC method described above; the copolymer had an M_{w} of 396,650 Da and M_{w}/Mₙ of 2.7 based on two independent measurements. The product was a copolymer of TCHMA, HEMA, and MAA containing random side chains of TMI attached to HEMA and was designated herein as TCHMA/HEMA-TMI/MAA (96.4/3.1-4.7/0.5 w/w) and suitable for making an organosol containing polar groups in the shell. The shell co-polymer had a T_{g} of 96° C.

### Example 3

### TCHMA/HEMA-TMI/DMAEMA (91/3-4.7/6)

A 5000 ml, 3-neck round flask equipped with a condenser, a thermocouple connected to a digital temperature controller, a nitrogen inlet tube connected to a source of dry nitrogen and a mechanical stirrer, was charged with a mixture of 2561 g of Norpar™ 12, 796.3 g of TCHMA, 52.5 g of DMAEMA, 26.8 g of 98% (w/w) HEMA, and 8.75 g of V-601. While stirring the mixture, the reaction flask was purged with dry nitrogen for 30 minutes at flow rate of approximately 2 liters/minute. A hollow glass stopper was then inserted into the open end of the condenser and the nitrogen flow rate was reduced to approximately 0.5 liters/minute. The mixture was heated to 70° C. for 16 hours. The conversion was quantitative.

The mixture was then heated to 90° C. and held at that temperature for 1 hour to destroy any residual V-601, and then was cooled back to 70° C. The nitrogen inlet tube was then removed, and 13.6 g of 95% (w/w) DBTDL were added to the mixture, followed by 41.1 g of TMI. The TMI was added drop wise over the course of approximately 5 minutes while stirring the reaction mixture. The nitrogen inlet tube was replaced, the hollow glass stopper in the condenser was removed, and the reaction flask was purged with dry nitrogen for 30 minutes at a flow rate of approximately 2 liters/minute. The hollow glass stopper was reinserted into the open end of the condenser and the nitrogen flow rate was reduced to approximately 0.5 liters/min. The mixture was allowed to react at 70° C. for 6 hours, at which time the conversion was quantitative.

The mixture was then cooled to room temperature. The cooled mixture was a viscous, transparent liquid containing no visible insoluble mater. The percent solids of the liquid mixture was determined to be 26.6% (w/w) using the thermogravimetric method described above. Subsequent determination of molecular weight was made using the GPC method described above; the copolymer had an M_{w} of 366,900 Da and M_{w}/Mₙ of 1.2 based on two independent measurements. The product was a copolymer of TCHMA, HEMA, and DMAEMA with a TMI grafting site and was designated herein as TCHMA/HEMA-TMI/DMAEMA (91/3-4.7/6% wlw) and suitable for making an organosol. The glass transition temperature was measured using DSC, as described above. The shell co-polymer had a T_{g} of 112° C.

Non-Graft Dispersants

### Example 4

### LMA/MAA (98/2)

A 32 ounce (0.72 liter), narrow-mouthed glass bottle was charged with 448.5 g of Norpar™ 12, 147 g of LMA, 3.0 g of MAA, and 1.5 g of V-601. The bottle was then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 16 hours at which time the conversion of monomer to polymer was quantitative.

The cooled mixture was a viscous, transparent liquid containing no visible insoluble matter. The percent solids of the liquid mixture was determined to be 25.5% (w/w) using the thermogravimetric method described above. Subsequent determination of molecular weight was made using the GPC method described above; the copolymer had a M_{w} of 165,900 Da and M_{w}/Mₙ of 2.19 based on two independent measurements. The measured glass transition temperature of the polymer was −62.5° C., as determined by DSC using the method described above.

### Example 5

### LMA/DMAEMA (97/3)

A 32 ounce (0.72 liter), narrow-mouthed glass bottle was charged with 448.5 g of Norpar™ 12, 145.5 g of LMA, 4.5 g of DMAEMA, and 1.5 g of V-601. The bottle was then sealed with a screw cap fitted with a Teflon liner and the cap was secured in place using electrical tape. The sealed bottle was inserted into a metal cage assembly and installed on the agitator assembly of an Atlas Launder-Ometer (Atlas Electric Devices Company, Chicago, Ill.). The Launder-Ometer was operated at its fixed agitation speed of 42 RPM with a water bath temperature of 75° C. The mixture in the sealed bottle was allowed to react for 16 hours at which time the conversion of monomer to polymer was quantitative.

The cooled mixture was a viscous, transparent liquid containing no visible insoluble matter. The percent solids of the liquid mixture was determined to be 24.4% (w/w) using the thermogravimetric method described above. Subsequent determination of molecular weight was made using the GPC method described above; the copolymer had a M_{w} of 238,800 Da and M_{w}/Mₙ of 1.32 based on two independent measurements. The measured glass transition temperature of the polymer was −63.2° C., as determined by DSC using the method described above.

Organosol Preparation

### Example 6

### TCHMA/HEMA-TMI//EMA (97/3-4.7 1//100)

This example illustrates the use of graft stabilizer from example 1 to prepare an organosol that has a D/S ratio of 8. A 2128 liter (560 gallon) reactor, equipped with a condenser, a thermocouple connected to a digital temperature controller, a nitrogen inlet tube connected to a source of dry nitrogen and a mixer, was thoroughly cleaned with a heptane reflux and then thoroughly dried at 100° C. under vacuum. A nitrogen blanket was applied and the reactor was allowed to cool to ambient temperature. The reactor was charged with a mixture of 689.5 kg (1520 lbs) of Norpar™ 12 and 43.9 kg (96.7 lbs.) of the graft stabilizer mixture from comparative example 1 @ 26.2% (w/w) polymer solids along with an additional 4.31 kg (9.5 lbs) of Norpar™ 12 to rinse the pump. Agitation was then turned on at a rate of 65 RPM, and temperature was check to ensure maintenance at ambient. Next 92.11 kg (203 lbs) of EMA was added along with 25.86 kg (57 lbs) Norpar™ 12 for rinsing the pump. Finally 1.03 kg (2.28 lbs) of V-601 was added, along with 4.31 kg (9.5 lbs) of Norpar™ 12 to rinse the container. A full vacuum was then applied for 10 minutes, and then broken by a nitrogen blanket. A second vacuum was pulled for 10 minutes, and then agitation stopped to verify that no bubbles were coming out of the solution. The vacuum was then broken with a nitrogen blanket and a light flow of nitrogen of 14.2 l/hr was applied. Agitation of 80 RPM was resumed and the temperature of the reactor was heated to 75° C. and maintained for 6 hours. The conversion was quantitative.

86.21 kg (190 lbs) of n-heptane and 172.41 kg (380 lbs.) of Norpar™ 12 were added to the cooled organosol. The resulting mixture was stripped of residual monomer using a rotary evaporator equipped with a dry ice/acetone condenser. Agitation was held at 80 RPM and the batch heated to 95° C. The nitrogen flow was stopped and a vacuum of 126 torr was pulled and held for 10 minutes. The vacuum was then increased to 80, 50, and 31 torr, being held at each level for 10 minutes. The vacuum was increased to 20 torr and held for 30 minutes. At that point a full vacuum is pulled and 372 kg (820 lbs.) of distillate was collected. Another 86.21 kg (190 lbs.) of n-heptane and 172.41 kg (380 lbs.) of Norpar™ 12 were added to the organosol. Agitation was held at 80 RPM and the batch heated to 95° C. The nitrogen flow was stopped and a vacuum of 126 torr was pulled and held for 10 minutes. The vacuum was then increased to 80, 50, and 31 torr, being held at each level for 10 minutes. Finally, the vacuum was increased to 20 torr and held for 30 minutes. At that point a full vacuum is pulled and an additional 603 lbs of distillate was collected. The vacuum was then broken, and the stripped organosol was cooled to room temperature, yielding an opaque white dispersion.

This organosol is designated TCHMA/HEMA-TMI//EMA (97/3-4.7//100% w/w). The percent solids of the organosol dispersion after stripping was determined to be 13.2% (w/w) using the thermogravimetric method described above. Subsequent determination of average particles size was made using the light scattering method described above; the organosol had a volume average diameter of 33.80 μm. The glass transition temperature was measured using DSC, as described above. The organosol particles had a T_{g} of 68.1° C.

Preparation of Liquid Inks

### Example 7

### Comparative

This is an example of preparing a black liquid toner at an organosol pigment ratio of 6 using the organosol prepared at a core/shell ratio of 8 in example 6. 253.2 g of the organosol @ 13.2% (w/w) solids in Norpar™ 12 were combined with 37.8 g of Norpar™ 12, 5.6 g of Black Pigment (Aztech BK8200, Magruder Color Company, Tucson Ariz.), and 3.3 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 85 minutes at room temperature.

The percent solids of the toner concentrate was determined to be 10.6% (w/w) using the thermogravimetric method described above. Average particle size was made using the Horiba LA-920 laser diffraction method described above.
Volume Mean Particle Size: 4.9 micron
Q/M: 747 μC/g
Bulk Conductivity: 738 picoMhos/cm
Percent Free Phase Conductivity: 1.30%
Dynamic Mobility: 6.44E- II (m²/Vsec)
   This toner was tested on the printing apparatus described previously. The reflection optical density (OD) was 1.00 at plating voltages greater than 450 volts.

### Example 8

This is an example of preparing a black liquid toner at an organosol pigment ratio of 6 using the organosol prepared at a core/shell ratio of 8 in example 6. 253.2 g of the organosol @ 13.2% (w/w) solids in Norpar™ 12 were combined with 37.8 g of Norpar™ 12, 5.6 g of Black Pigment (Aztech BK8200, Magruder Color Company, Tucson Ariz.), 12.56 g of the graft dispersant from example 2 @ 26.5% and 3.3 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 75 minutes at room temperature.

The percent solids of the toner concentrate was determined to be 11% (w/w) using the thermogravimetric method described above. Average particle size was made using the Horiba LA-920 laser diffraction method described above.
Volume Mean Particle Size: 5.0 micron
Q/M: 875 μC/g
Bulk Conductivity: 1123 picoMhos/cm
Percent Free Phase Conductivity: 11.38%
Dynamic Mobility: 4.20E-11 (m²/Vsec)
   This toner was tested on the printing apparatus described previously. The reflection optical density (OD) was 0.69 at plating voltages greater than 450 volts.

### Example 9

This is an example of preparing a black liquid toner at an organosol pigment ratio of 6 using the organosol prepared at a core/shell ratio of 8 in example 6. 253.2 g of the organosol @ 13.2% (w/w) solids in Norpar™ 12 were combined with 37.8 g of Norpar™ 12, 5.6 g of Black Pigment (Aztech BK8200, Magruder Color Company, Tucson Ariz.), 13.1 g of the non-graft dispersant from example 4 @ 25.5% and 3.3 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 60 minutes at room temperature.

The percent solids of the toner concentrate was determined to be 12.2% (w/w) using the thermogravimetric method described above. Average particle size was made using the Horiba LA-920 laser diffraction method described above.
Volume Mean Particle Size: 4.5 micron
Q/M: 374 μC/g
Bulk Conductivity: 264 picoMhos/cm
Percent Free Phase Conductivity: 17.03%
Dynamic Mobility: 7.28E-11 (m²/Vsec)
   This toner was tested on the printing apparatus described previously. The reflection optical density (OD) was 0.868 at plating voltages greater than 450 volts.

### Example 10

### Comparative

This is an example of preparing a yellow liquid toner at an organosol pigment ratio of 6 using the organosol prepared at a core/shell ratio of 8 in example 6. 253.2 g of the organosol @ 13.2% (w/w) solids in Norpar™ 12 were combined with 39 g of Norpar™ 12, 5.6 g of Yellow PY 83 (Sun Chemical, Cincinnati, Ohio), and 2.2 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 60 minutes at room temperature.

The percent solids of the toner concentrate was determined to be 11.3% (w/w) using the thermogravimetric method described above. Average particle size was made using the Horiba LA-920 laser diffraction method described above.
Volume Mean Particle Size: 5.2 micron
Q/M: 179 μC/g
Bulk Conductivity: 40 picoMhos/cm
Percent Free Phase Conductivity: 2.42%
Dynamic Mobility: 1.80E-11 (m²/Vsec)
   This toner was tested on the printing apparatus described previously. The reflection optical density (OD) was 0.85 at plating voltages greater than 450 volts.

### Example 11

This is an example of preparing a yellow liquid toner at an organosol pigment ratio of 6 using the organosol prepared at a core/shell ratio of 8 in example 6. 253.2 g of the organosol @ 13.2% (w/w) solids in Norpar™ 12 were combined with 39 g of Norpar™ 12, 5.6 g of Yellow PY 83 (Sun Chemical, Cincinnati, Ohio), 12.56 g of the graft dispersant from example 2 @ 26.5% and 2.2 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 65 minutes at room temperature.

The percent solids of the toner concentrate was determined to be 12.2% (w/w) using the thermogravimetric method described above. Average particle size was made using the Horiba LA-920 laser diffraction method described above.
Volume Mean Particle Size: 5.0 micron
Q/M: 149 μC/g
Bulk Conductivity: 105 picoMhos/cm
Percent Free Phase Conductivity: 4.39%
Dynamic Mobility: 2.84E-11 (m²/Vsec)
   This toner was tested on the printing apparatus described previously. The reflection optical density (OD) was 0.99 at plating voltages greater than 450 volts.

### Example 12

This is an example of preparing a yellow liquid toner at an organosol pigment ratio of 6 using the organosol prepared at a core/shell ratio of 8 in example 6. 253.2 g of the organosol @ 13.2% (w/w) solids in Norpar™ 12 were combined with 39 g of Norpar™ 12, 5.6 g of Yellow PY 83 (Sun Chemical, Cincinnati, Ohio), 13.1 g of the non-graft dispersant mixture from example 4 @ 25.5% and 2.2 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 60 minutes at room temperature.

The percent solids of the toner concentrate was determined to be 12.3% (w/w) using the thermogravimetric method described above. Average particle size was made using the Horiba LA-920 laser diffraction method described above.
Volume Mean Particle Size: 5.2 micron
Q/M: 55 μC/g
Bulk Conductivity: 12 picoMhos/cm
Percent Free Phase Conductivity: 74.56%
Dynamic Mobility: 1.09E-11 (m²Nsec)
   This toner was tested on the printing apparatus described previously. The reflection optical density (OD) was 0.21 at plating voltages greater than 450 volts.

### Example 13

### Comparative

This is an example of preparing a black liquid toner at an organosol pigment ratio of 6 using the organosol prepared at a core/shell ratio of 8 in example 6. 253.2 g of the organosol @ 13.2% (w/w) solids in Norpar™ 12 were combined with 37.8 g of Norpar™ 12, 5.6 g of Cabot Black Pigment Mogul L (Cabot Corporation, Billerica, Mass.), and 3.3 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 60 minutes at room temperature.

The percent solids of the toner concentrate was determined to be 11.1% (w/w) using the thermogravimetric method described above. Average particle size was made using the Horiba LA-920 laser diffraction method described above.
Volume Mean Particle Size: 5.2 micron
Q/M: 67 μC/g
Bulk Conductivity: 8.8 picoMhos/cm
Percent Free Phase Conductivity: 10.95%
Dynamic Mobility: 6.1 OE-12 (m²/Vsec)
   This toner was tested on the printing apparatus described previously. The reflection optical density (OD) was 0.190 at plating voltages greater than 450 volts.

### Example 14

This is an example of preparing a black liquid toner at an organosol pigment ratio of 6 using the organosol prepared at a core/shell ratio of 8 in example 6. 253.2 g of the organosol @ 13.2% (w/w) solids in Norpar™ 12 were combined with 37.8 g of Norpar™ 12, 5.6 g of Cabot Black Pigment Mogul L (Cabot Corporation, Billerica, Mass.), 12.56 g of the graft dispersant from example 3 @ 26.6% and 3.3 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 60 minutes at room temperature.

The percent solids of the toner concentrate was determined to be 11.6% (w/w) using the thermogravimetric method described above. Average particle size was made using the Horiba LA-920 laser diffraction method described above.
Volume Mean Particle Size: 5.2 micron
Q/M: 150 μC/g
Bulk,Conductivity: 239 picoMhos/cm
Percent Free Phase Conductivity: 45.56%
Dynamic Mobility: 3.22E-11 (m²/Vsec)
   This toner was tested on the printing apparatus described previously. The reflection optical density (OD) was 1.197 at plating voltages greater than 450 volts.

### Example 15

This is an example of preparing a black liquid toner at an organosol pigment ratio of 6 using the organosol prepared at a core/shell ratio of 8 in example 6. 253.2 g of the organosol @ 13.2% (w/w) solids in Norpar™ 12 were combined with 37.8 g of Norpar™ 12, 5.6 g of Cabot Black Pigment Mogul L (Cabot Corporation, Billerica, Mass.), 13.7 g of the non-graft dispersant from example 5 @ 24.4% and 3.3 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 60 minutes at room temperature.

The percent solids of the toner concentrate was determined to be 12.7% (w/w) using the thermogravimetric method described above. Average particle size was made using the Horiba LA-920 laser diffraction method described above.
Volume Mean Particle Size: 4.5 micron
Q/M: 133 μC/g
Bulk Conductivity: 102 picoMhos/cm
Percent Free Phase Conductivity: 69.63%
Dynamic Mobility: 7.38E-12 (m²Nsec)
   This toner was tested on the printing apparatus described previously. The reflection optical density (OD) was 0.158 at plating voltages greater than 450 volts.

### Example 16

### Comparative

This is an example of preparing a cyan liquid toner at an organosol pigment ratio of 6 using the organosol prepared at a core/shell ratio of 8 in example 6. 253.2 g of the organosol @ 13.2% (w/w) solids in Norpar™ 12 were combined with 39 g of Norpar™ 12, 5.6 g of Cyan Pigment PB 15:4 (Sun Chemical, Cincinnati, Ohio), and 2.2 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 60 minutes at room temperature.

The percent solids of the toner concentrate was determined to be 9.8% (w/w) using the thermogravimetric method described above. Average particle size was made using the Horiba LA-920 laser diffraction method described above.
Volume Mean Particle Size: 5.1 micron
Q/M: 257 μC/g
Bulk Conductivity: 153 picoMhos/cm
Percent Free Phase Conductivity: 0.38%
Dynamic Mobility: 4.69E-11 (m²/Vsec)

This toner was tested on the printing apparatus described previously. The reflection optical density (OD) was 1.159 at plating voltages greater than 450 volts.

### Example 17

This is an example of preparing a cyan liquid toner at an organosol pigment ratio of 6 using the organosol prepared at a core/shell ratio of 8 in example 6. 253.2 g of the organosol @ 13.2% (w/w) solids in Norpar™ 12 were combined with 39 g of Norpar 12, 5.6 g of Cyan Pigment PB 15:4 (Sun Chemical, Cincinnati, Ohio), 12.56 g of the graft dispersant mixture from example 3 @ 26.6% and 2.2 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.). The mill was operated at 2,000 RPM for 45 minutes at room temperature.

The percent solids of the toner concentrate was determined to be 11.6% (w/w) using the thermogravimetric method described above. Average particle size was made using the Horiba LA-920 laser diffraction method described above.
Volume Mean Particle Size: 5.4 micron
Q/M: 378 μC/g
Bulk Conductivity: 316 picoMhos/cm
Percent Free Phase Conductivity: 13.7%
Dynamic Mobility: 3.48E-11 (m²/Vsec)
   This toner was tested on the printing apparatus described previously. The reflection optical density (OD) was 1.287 at plating voltages greater than 450 volts.

### Example 18

This is an example of preparing a cyan liquid toner at an organosol pigment ratio of 6 using the organosol prepared at a core/shell ratio of 8 in example 6. 253.2 g of the oranganosol @ 13.2% (w/w) solids in Norpar™ 12 were combined with 39 g of Nopar™ 12, 5.6 g of Cyan Pigment PB 15:4 (Sun Chemical, Cincinnati, Ohio), 13.7 g of the non-graft dispersant mixture from example 5 @ 24.4% and 2.2 g of a 5.0% (w/w) Zirconium HEX-CEM solution in an 8 ounce glass jar. This mixture was then milled in a 0.5 liter vertical bead mill (Model 6TSG-1/4, Aimex Co., Ltd., Tokyo, Japan) charged with 390 g of 1.3 mm diameter Potters glass beads (Potters Industries, Inc., Parsippany, N.J.) The mill was operated at 2,000 RPM for 60 minutes at room temperature.

The percent solids of the toner concentrate was determined to be 12.7% (w/w) using the thermogravimetric method described above. Average particle size was made using the Horiba LA-920 laser diffraction method described above.
Volume Mean Particle Size: 4.6 micron
Q/M: 282 μC/g
Bulk Conductivity: 154 picoMhos/cm
Percent Free Phase Conductivity: 11.12%
Dynamic Mobility: 3.07E-11 (m²/Vsec)

This toner was tested on the printing apparatus described previously. The reflection optical density (OD) was 1.21 at plating voltages greater than 450 volts.

TABLE 1
Maximum OD and Viscosity

| Basic pigment and acid-functional dispersant. | | | Maximum | | Initial | Viscosity | Viscosity |
|---|---|---|---|---|---|---|---|
| Example | Basic | Acidic | Max | 2 weeks | Viscosity | 1 week @ 55 C. | 2 weeks @ 55 C. |
| Number | Pigment | Dispersant | OD | at 55 C. | centipoise | centipoise | centipoise |
| 7 (Comp) | BK8200 | None | 1 | 1.1 | 53 | 440 | 3100 |
| 8 | BK8200 | TCHMA/HEMA-TMI/MAA | 0.69 | 0.81 | 175 | 250 | 325 |
| 9 | BK8200 | LMA/MAA | 0.868 | 1.04 | 58 | 139 | 215 |
| 10 (Comp) | PY 83 | None | 0.85 | 0.79 | 75 | 525 | 700 |
| 11 | PY 83 | TCHMA/HEMA-TMI/MAA | 0.99 | 1.07 | 9 | 45 | 400 |
| 12 | PY 83 | LMA/MAA | 0.21 | 0.67 | 93 | 175 | 590 |

TABLE 2
Maximum OD and Viscosity

| Acidic pigment and basic-functional | | | | | | | |
|---|---|---|---|---|---|---|---|
| dispersant. | | | Maximum | | Initial | Viscosity | Viscosity |
| Example | Acidic | Basic | Max | 2 weeks | Viscosity | 1 week @ 55 C. | 2 weeks @ 55 C. |
| Number | Pigment | Dispersant | OD | at 55 C. | centipoise | centipoise | centipoise |
| 13 (Comp) | Mogul L | None | 0.19 | 0.58 | 202.5 | 2250 | 2460 |
| 14 | Mogul L | TCHMA/HEMA- | 1.197 | 1.23 | 55 | 1050 | 1400 |
| | | TMI/DMAEMA | | | | | |
| 15 | Mogul L | LMA/DMAEMA | 0.158 | 0.224 | 58 | 156 | 430 |
| 16 (Comp) | PB 15:4 | None | 1.159 | 1.22 | 43.5 | 475 | 490 |
| 17 | PB 15:4 | TCHMA/HEMA- | 1.287 | 1.3 | 17 | 170 | 160 |
| | | TMI/DMAEMA | | | | | |
| 18 | PB 15:4 | LMA/DMAEMA | 1.21 | 1.06 | 65 | 435 | 1775 |

A number of embodiments of the invention have been described. Nevertheless, it will be understood that various modifications may be made without departing from the spirit and scope of the invention. Accordingly, other embodiments are within the scope of the following claims.

1. A liquid ink comprising:
a) a carrier liquid having a Kauri-Butanol number less than 30;
b) a pigment having at least one surface acid group or at least one surface basic group;
c) a dispersant having, respectively, at least an amine group or at least one acid group to form an acid-base pigment-dispersant system or a base-acid pigment-dispersant system, wherein the mole ratio of the amine group to the acid group is between 0.3 and 1.5 in the base-acid pigment-dispersant system and the mole ratio of the acid group to the base group in the acid-base pigment dispersant system is between 0.3 and 1.5; and
d) a positive charge director with the acid-base charge pigment-dispersant system and a negative charge director with the base-acid charge pigment-dispersant system.

2. A liquid ink according to claim 1, wherein the liquid ink further comprises a copolymer associated with the pigment.

3. The liquid ink of claim 2 wherein the copolymer comprises a grafted co-polymer.

4. The liquid ink of claim 3 wherein the grafted copolymer comprises a (co)polymeric steric stabilizer covalently bonded to a thermoplastic (co)polymeric core that is insoluble in the carrier liquid, wherein the grafted co-polymer is derived from at least a polymerizable organic compound.

5. The liquid ink of claim 4 wherein the grafted copolymer comprises a base-acid copolymer-dispersant system and the grafted co-polymer has an acid value greater than 10 mg KOH/g and there is a positive charge director present in the ink.

6. A liquid ink according to claim 4 wherein the pigment-dispersant system comprises a base-acid pigment-dispersant system and the grafted co-polymer has an acid value greater than 20 mg KOH/g and there is a positive charge director present in the ink.

7. A liquid ink according to claim 4 wherein the pigment-dispersant system comprises a base-acid pigment-dispersant system and the dispersant comprises a polyester and there is a positive charge director present in the ink.

8. A liquid ink according to claim 4 wherein the pigment-dispersant system comprises a base-acid pigment-dispersant system and the charge director comprises at least an organic acid metal salt and there is a positive charge director present in the ink.

9. A liquid ink according to claim 6 wherein the pigment-dispersant system comprises an acid-base pigment dispersant system and the grafted co-polymer has an amine value in the range of 3 to 60 mg KOH/g and there is a negative charge director present in the ink.

10. A liquid ink according to claim 4 wherein the pigment-dispersant system comprises an acid-base pigment dispersant system and the grafted co-polymer has an amine value in the range of 5 to 50 mg KOH/g and there is a negative charge director present in the ink.

11. A liquid ink according to claim 4 wherein the pigment-dispersant system comprises an acid-base pigment dispersant system and the grafted co-polymer has an amine value in the range of 10 to 40 mg KOH/g and there is a negative charge director present in the ink.

12. A liquid ink according to claim 4 wherein the pigment-dispersant system comprises an acid-base pigment dispersant system and the thermoplastic (co)polymeric core comprises at least an amine group and there is a negative charge director present in the ink.

13. A liquid ink according to claim 4 wherein the pigment-dispersant system comprises an acid-base pigment dispersant system and the mole ratio of the acid group to the amine group is between 0.4 and 1.0 and there is a negative charge director present in the ink.

14. A liquid ink according to claim 1 wherein the pigment-dispersant system comprises an acid-base pigment dispersant system and there is a negative charge director in the ink that is selected from the group containing lecithin, (meth)acrylates having an aliphatic amino group, vinyl monomers having nitrogen-containing heterocyclic ring, cyclic amide monomers having N-vinyl substituent, (meth)acrylamides, aromatic substituted ethlylenic monomers having nitrogen-containing group, nitrogen-containing vinyl ether monomers.

15. A liquid ink according to claim 1 wherein the pigment-dispersant system comprises an acid-base pigment-dispersant system and there is a negative charge director present in the ink and the negative charge director comprises lecithin.

16. A liquid ink according to claim 1 wherein the pigment-dispersant system comprises an acid-base pigment-dispersant system and there is a dispersant present and the dispersant comprises a polyester.
